(19) United States
(12) Patent Application Publication
(10) Pub. No.: US 2026/0094844 A1
(43) Pub. Date: Apr. 2, 2026

(54) SOLID-STATE CELL EDGE TAPER SYSTEM AND METHOD

(71) Applicant: Apple Inc., Cupertino, CA (US)

(72) Inventors: Shawn W. Snyder, Santa Cruz, CA (US); Martin Bettge, San Jose, CA (US); Qiang Liu, Santa Clara, CA (US); Arifur Rahaman, San Jose, CA (US)

(21) Appl. No.: 19/295,303

(22) Filed: Aug. 8, 2025

Related U.S. Application Data
(60) Provisional application No. 63/700,409, filed on Sep. 27, 2024.

(51) Int. Cl. H01M 4/70; H01M 4/04; H01M 4/525; H01M 4/66; H01M 10/0562; H01M 50/437

(52) U.S. Cl. CPC H01M 4/70; H01M 4/525; H01M 4/661; H01M 10/0562; H01M 50/437; H01M 4/0445; H01M 2300/0068

(57) ABSTRACT

A multi-layer battery assembly comprising a cathode current collector layer, a cathode active material layer, a solid-state electrolyte layer, and an anode current collector layer. The cathode active material layer is positioned between and in contact with the cathode current collector layer and the solid-state electrolyte layer. The solid-state electrolyte layer is positioned between and in contact with the cathode active material layer and the anode current collector layer. The cathode active material layer comprises a tapered edge extending between the cathode current collector layer and the solid-state electrolyte layer.

### CROSS-REFERENCE TO RELATED APPLICATION

This application claims priority to U.S. Provisional Application No. 63/700,409, filed Sep. 27, 2024, which is incorporated by reference herein in its entirety.

### BACKGROUND

The present disclosure relates generally to a battery, such as a secondary or rechargeable battery (e.g., lithium-ion battery), and more specifically to lithium plating in a solid-state anode-free battery (AFB).

Certain conventional batteries may include a cathode, such as a cathode current collector layer and a cathode active material layer disposed on the cathode current collector layer, and an anode, such as an anode current collector layer and an anode active material layer disposed on the anode current collector layer. However, the anode active material layer increases a size, a weight, and/or a material cost of such conventional batteries. Further, certain conventional battery wafers including a plurality of interconnected conventional batteries (e.g., having both the cathode active material layer and the anode active material layer) encounter various undesirable manufacturing complexities. For example, certain such conventional battery wafers must be cut into individual conventional batteries from the anode side of the conventional battery wafer after removing at least some lithium therefrom (e.g., to avoid shorting).

Solid-state anode-free batteries (AFBs), or lithium seed-free batteries, are designed without the anode active material layer, thereby reducing or negating at least some of the problems described above with respect to the conventional batteries having both the cathode active material layer and the anode active material layer. For example, a solid-state AFB may be activated during an initial charging cycle that causes lithium in the cathode active material layer to migrate toward the anode current collector layer, thereby generating a lithium plating layer between the anode current collector layer and a solid-state electrolyte layer of the solid-state AFB. However, such solid-state AFBs may be prone to plating activity (e.g., caused by the initial charging cycle) at an edge of the solid-state AFB, such as at an edge of the solid-state electrolyte layer and/or the anode current collector layer. Such plating activity may cause shorting during or after the initial charging cycle, among other undesirable technical problems. Accordingly, it is now recognized that improved systems and methods employing solid-state AFBs are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a multi-layer battery assembly comprising a cathode current collector layer, a cathode active material layer, a solid-state electrolyte layer, and an anode current collector layer. The cathode active material layer is positioned between and in contact with the cathode current collector layer and the solid-state electrolyte layer. The solid-state electrolyte layer is positioned between and in contact with the cathode active material layer and the anode current collector layer. The cathode active material layer comprises a tapered edge extending between the cathode current collector layer and the solid-state electrolyte layer.

In another embodiment, a multi-layer battery assembly includes a cathode current collector layer, a cathode active material layer, a solid-state electrolyte layer, a lithium plating layer, and an anode current collector layer. The cathode active material layer is positioned between and in contact with the cathode current collector layer and the solid-state electrolyte layer. The solid-state electrolyte layer is positioned between and in contact with the cathode active material layer and the lithium plating layer. The lithium plating layer is positioned between and in contact with the solid-state electrolyte layer and the anode current collector layer. The cathode active material layer comprises a tapered edge extending between the cathode current collector layer and the solid-state electrolyte layer.

In another embodiment, a wafer includes a plurality of interconnected multi-layer battery assemblies. Each multi-layer battery assembly of the plurality of interconnected multi-layer battery assemblies includes a cathode current collector layer, a cathode active material layer, a solid-state electrolyte layer, and an anode current collector layer. The cathode active material layer is positioned between and in contact with the cathode current collector layer and the solid-state electrolyte layer. The solid-state electrolyte layer is positioned between and in contact with the cathode active material layer and the anode current collector layer. The cathode active material layer comprises a tapered edge extending between the cathode current collector layer and the solid-state electrolyte layer.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a multi-layer battery assembly before and after an initial charging cycle that generates a lithium plating layer between an electrolyte layer (e.g., solid-state electrolyte later) of the multi-layer battery assembly and an anode current collector layer of the multi-layer battery assembly, according to embodiments of the present disclosure;

FIG. 3 is a schematic cross-sectional view of the multi-layer battery assembly of FIG. 2 before the initial charging cycle, where a cathode active material layer of the multi-layer battery assembly includes a tapered edge (e.g., forming an acute angle with an electrolyte layer of the multi-layer battery assembly), according to embodiments of the present disclosure;

FIG. 4 is a schematic cross-sectional view of the multi-layer battery assembly of FIG. 2 after the initial charging cycle, where a cathode active material layer of the multi-layer battery assembly includes a tapered edge (e.g., forming an acute angle with an electrolyte layer of the multi-layer battery assembly), and a lithium plating layer of the multi-layer battery assembly includes an additional tapered edge, according to embodiments of the present disclosure;

FIG. 5 is a schematic cross-sectional view of a portion of a wafer including a first instance of the multi-layer battery assembly of FIG. 2 before the initial charging cycle and a second instance of the multi-layer battery assembly of FIG. 2 before the initial charging cycle, where the second instance is connected with (and configured to be cut from) the first instance, according to embodiments of the present disclosure;

FIG. 6 is a schematic cross-sectional view of a portion of a wafer including the multi-layer battery assembly of FIG. 2 before the initial charging cycle and waste material, where the waste material is connected with (and configured to be cut from) the multi-layer battery assembly, according to embodiments of the present disclosure;

FIG. 7 is a perspective view of a wafer including a plurality of instances of the multi-layer battery assembly of FIG. 2 and waste material before a cutting process and the initial charging cycle, according to embodiments of the present disclosure;

FIG. 8 is a perspective view of a groove in a portion of the wafer of FIG. 7, according to embodiments of the present disclosure;

FIG. 9 is a process flow diagram illustrating a method of manufacturing a plurality of multi-layer battery assemblies from a wafer, according to embodiments of the present disclosure;

FIG. 10 is a schematic cross-sectional view of the multi-layer battery assembly of FIG. 2 before the initial charging cycle, where a cathode active material layer of the multi-layer battery assembly includes a tapered edge (e.g., forming an acute angle with a cathode current collector layer of the multi-layer battery assembly), according to embodiments of the present disclosure; and

FIG. 11 is a schematic cross-sectional view of the multi-layer battery assembly of FIG. 2 after the initial charging cycle, where a cathode active material layer of the multi-layer battery assembly includes a tapered edge (e.g., forming an acute angle with a cathode current collector layer of the multi-layer battery assembly), and a lithium plating layer is formed between an electrolyte layer and an anode current collector layer of the multi-layer battery assembly, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to a battery, such as a secondary or rechargeable battery (e.g., lithium-ion battery), and more specifically a tapered edge of a cathode active material layer of a solid-state anode-free battery (AFB), which is configured to promote an additional tapered edge of a lithium plating layer of the solid-state AFB during an initial charging cycle of the solid-state AFB. Additionally, the present disclosure relates to a wafer having a plurality of interconnected solid-state AFBs configured to be cut into individual solid-state AFBs.

The solid-state AFB may be referred in certain instances of the present disclosure as a lithium seed-free battery, a multi-layer solid-state AFB assembly, or a multi-layer battery assembly for short. The multi-layer battery assembly may include, prior to an initial charging cycle, a cathode current collector layer, a cathode active material layer, a solid-state electrolyte layer, and an anode current collector layer. The multi-layer battery assembly may not include, prior to the initial charging cycle, an anode active material layer. The cathode active material layer may be disposed between (and in contact with) the cathode current collector layer and the solid-state electrolyte layer. The solid-state electrolyte layer may be disposed between (and in contact with) the solid-state electrolyte layer and the anode current collector layer.

The cathode current collector layer may include, for example, aluminum, gold, nickel, or any combination thereof. As an example, the cathode current collector layer may include multiple sub-layers in certain embodiments, such as an aluminum sub-layer and one or more of a gold sub-layer or a nickel sub-layer. The cathode active material layer may include, for example, lithium cobalt oxide (LCO). The solid-state electrolyte layer may include, for example, glass, ceramics, solid polymers, or a combination thereof. The anode current collector layer may include, for example, copper (Cu). In some embodiments, a platinum film may form a portion of the anode current collector layer 58 and/or one of the other layers of the multi-layer battery assembly 50.

During the initial charging cycle, lithium from the cathode active material layer may migrate toward the anode current collector layer. In some embodiments, the solid-state electrolyte layer is porous, perforated, or otherwise permeable to the lithium from the cathode active material layer. In this way, a lithium plating layer is formed between the solid-state electrolyte layer and the anode current collector layer by way of (e.g., during and/or following) the initial charging cycle. In accordance with the present disclosure, the cathode active material layer includes a tapered edge extending between the cathode current collector layer and the solid-state electrolyte layer. For example, a cross-sectional width of the cathode active material layer may increase from a position adjacent to the cathode current collector layer toward an additional position adjacent to the solid-state electrolyte layer. The tapered edge of the cathode active material layer, along with other possible features in accordance with the present disclosure, may cause an additional tapered edge of the lithium plating layer.

The tapered edge of the cathode active material layer, the additional tapered edge of the lithium plating layer, and the other possible features in accordance with the present disclosure, such as an exposed portion of the solid-state electrolyte layer that is not covered by the cathode active material layer, may reduce plating activity at one or more other edges of the multi-layer battery assembly, such as one or more edges of the solid-state electrolyte layer and/or the anode current collector layer. Because plating activity at such one or more other edges of the multi-layer battery assembly may otherwise increase a likelihood of shorting in the multi-layer battery assembly, presently disclosed features reducing or negating such plating activity at such one or more edges of the multi-layer battery assembly may reduce a likelihood of shorting in the multi-layer battery assembly. Other features according to the present disclosure include a wafer having a plurality of interconnected solid-state AFBs configured to be cut into individual solid-state AFBs. For example, the wafer may be configured to improve a cutting process and/or reduce negative effects associated with the cutting process in traditional configurations. These and other aspects of the present disclosure are described in detail below with reference to the drawings.

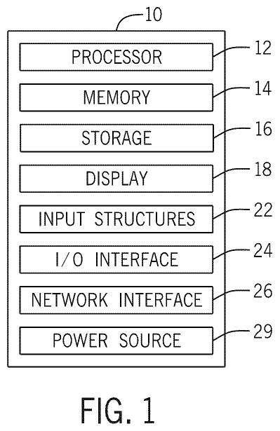

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

The power source 29 of the electronic device 10 may include any suitable source of power, such as a rechargeable lithium polymer battery (e.g., lithium-ion battery) and/or an alternating current (AC) power converter. In accordance with the present disclosure, the battery of the power source 29 may include a solid-state anode-free battery (AFB), also referred to in certain instances of the present disclosure as a lithium seed free battery and/or a multi-layer battery assembly (e.g., a multi-layer solid-state AFB assembly). The multi-layer battery assembly may include a cathode current collector layer, a cathode active material layer, an electrolyte layer (e.g., a solid-state electrolyte layer), and an anode current collector layer. The cathode current collector layer may include a tapered edge extending between the cathode current collector layer and the electrolyte layer. During an initial charging cycle of the multi-layer battery assembly, lithium migrates from the cathode active material layer toward the anode current collector, forming a lithium plating layer between the electrolyte layer and the anode current collector layer. In some embodiments, the solid-state electrolyte layer may be porous, perforated, or otherwise permeable to the lithium from the cathode active material layer.

The above-described tapered edge of the cathode active material layer promotes formation of an additional tapered edge in the lithium plating layer, where the tapered edge and the additional tapered edge (along with other possible features of the present disclosure, described in greater detail with reference to the drawings) reduce or negate plating activity along one or more other edges of the multi-layer battery assembly, such as an edge of the electrolyte layer and/or the anode current collector layer. By reducing or negating such plating activity, undesirable shorting of the multi-layer battery assembly is reduced or negated. Presently disclosed embodiments also relate to a wafer having a plurality of interconnected multi-layer battery assemblies, from which the multi-layer battery assembly described above and in greater detail below is cut. These and other aspects of the present disclosure are described in detail below with reference to the drawings.

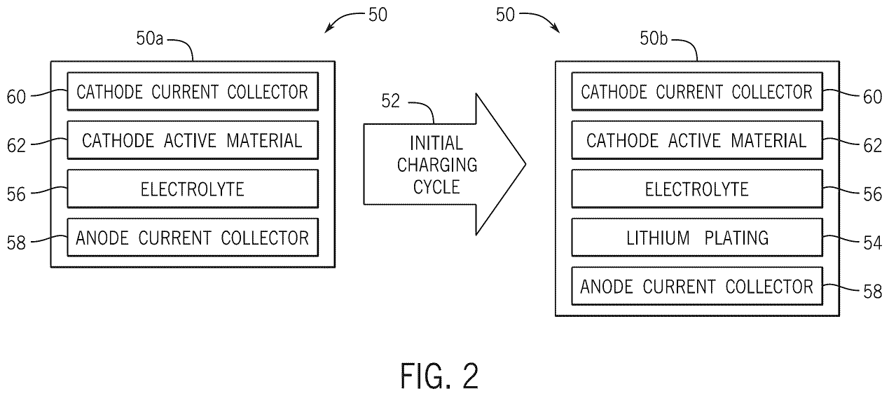

FIG. 2 is a block diagram of an embodiment of a multi-layer battery assembly 50 before and after an initial charging cycle 52 that generates a lithium plating layer 54 between an electrolyte layer 56 (e.g., solid-state electrolyte later) of the multi-layer battery assembly 50 and an anode current collector layer 58 of the multi-layer battery assembly 50. Reference numeral 50a is used to denote the multi-layer battery assembly 50 prior to the initial charging cycle 52, and reference numeral 50b is used to denote the multi-layer battery assembly 50 after the initial charging cycle 52.

Focusing first on the multi-layer battery assembly 50a prior to the initial charging cycle 52, the multi-layer battery assembly 50a includes a cathode current collector layer 60, a cathode active material layer 62, the electrolyte layer 56, and the anode current collector layer 58. The cathode active material layer 62 is disposed between (and in contact with) the cathode current collector layer 60 and the electrolyte layer 56, and the electrolyte layer 56 is disposed between (and in contact with) the cathode active material layer 62 and the anode current collector layer 58. The cathode current collector layer 60 may include, for example, aluminum, gold, nickel, or any combination (e.g., in one or more sub-layers of the cathode current collector layer 60). The cathode active material layer 62 may include, for example, lithium cobalt oxide (LCO). The electrolyte layer 56, which may be a solid-state electrolyte layer, may include, for example, glass, ceramics, solid polymers, or any combination thereof. The anode current collector layer 58 may include, for example, copper (Cu). In some embodiments, a platinum film may form a portion of the anode current collector layer 58 and/or one of the other layers of the multi-layer battery assembly 50.

During the initial charging cycle 52, lithium from the LCO of the cathode active material layer 62 may migrate toward the anode current collector layer 58, thereby forming a lithium plating layer 54 between the electrolyte layer 56 and the anode current collector layer 58. In this way, the LCO of the cathode active material layer 62 may be at least partially delithiated during the initial charging cycle 52. Further, the lithium plating layer 54 is formed in the multi-layer battery assembly 50b after the initial charging cycle 52, and is absent from the multi-layer battery assembly 50a prior to the initial charging cycle 52. Accordingly, after the initial charging cycle 52, the electrolyte layer 56 may be disposed between (and in contact with) the cathode active material layer 62 and the lithium plating layer 54, and the lithium plating layer 54 may be disposed between (and in contact with) the anode current collector layer 58.

As described in greater detail with reference to later drawings, the cathode active material layer 62 in FIG. 2 may include a tapered edge extending between the cathode current collector layer 60 and the electrolyte layer 56. For example, a cross-sectional width of the cathode active material layer 62 may be smaller at a position adjacent to the cathode current collector layer 60 than an additional position adjacent to the electrolyte layer 56. The tapered edge of the cathode active material layer 62 may promote an additional tapered edge of the lithium plating layer 54 between the electrolyte layer 56 and the anode current collector layer 58. In this way, a cross-sectional width of the lithium plating layer 54 may be smaller at a position adjacent to the anode current collector layer 58 than at an additional position adjacent to the electrolyte layer 56. By way of these features, lithium plating at an edge of the electrolyte layer 56 and/or the anode current collector layer 58 may be reduced or negated relative to traditional configurations, which reduces or negates a likelihood of shorting, in accordance with the present disclosure.

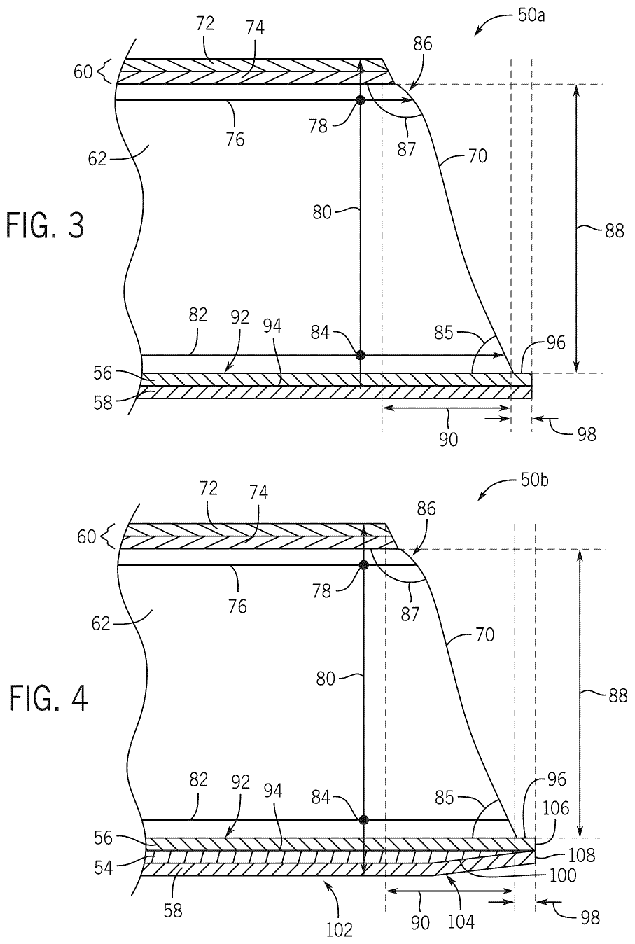

For example, FIG. 3 is a schematic cross-sectional view of the multi-layer battery assembly 50a of FIG. 2 (e.g., before the initial charging cycle 52 described above with respect to FIG. 2), where the cathode active material layer 62 of the multi-layer battery assembly 50a includes a tapered edge 70. Although only a portion of the multi-layer battery assembly 50a is illustrated in FIG. 3, it should be understood that another tapered edge similar to the tapered edge 70 shown in FIG. 3 may reside on an opposing side of the multi-layer battery assembly 50a not shown in FIG. 3. In the illustrated embodiment, the cathode current collector layer 60 includes at least two sub-layers, such as an aluminum sub-layer 72 and an additional sub-layer 74 having gold, nickel, or both. In some embodiments, the cathode active material layer 62 includes, in addition to the aluminum sub-layer 72, both a gold sub-layer and a nickel sub-layer. Thus, the cathode current collector layer 60 may include aluminum, gold, nickel, or any combination thereof (e.g., the aluminum sub-layer 72 and at least the additional sub-layer 74) in accordance with the present disclosure. Accordingly, the cathode active material layer 62 may be in contact with the cathode current collector layer 60 despite not contacting aluminum (e.g., the aluminum sub-layer 72) in certain embodiments.

The cathode active material layer 62 includes, by way of the tapered edge 70, a first cross-sectional width 76 at a first location 78 along a height 80 of the multi-layer battery assembly 50a, the first location 78 being adjacent to the cathode current collector layer 60, and a second cross-sectional width 82 at a second location 84 along the height 80 of the multi-layer battery assembly 50a, the second location 84 being adjacent to the electrolyte layer 56. The first cross-sectional width 76 and the second cross-sectional width 82 extend transverse to (e.g., substantially perpendicular to) the height 80 of the multi-layer battery assembly 50a, and the first cross-sectional width 76 extends substantially parallel to the second cross-sectional width 82. As shown, the first cross-sectional width 76 is less than the second cross-sectional width 82. In some embodiments, the tapered edge 70 is a flat slope from the cathode current collector layer 60 to the electrolyte layer 56, while in other embodiments, the tapered edge 70 may include some curvature therein (e.g., one or more curves or rounded portions therein). For example, in the embodiments illustrated in FIGS. 3 and 4, the tapered edge 70 includes a curved portion 86 (e.g., rounded portion) adjacent to the cathode current collector layer 60. In some embodiments, a shape of the tapered edge 70, such as a steepness, the curved portion 86, additional curved portions, etc., may be configured to reduce manufacturing complexities associated with extracting (e.g., via laser cutting from the cathode side) the multi-layer battery assembly 50a from a wafer of multiple interconnected instances of the multi-layer battery assembly 50a, described in greater detail with reference to later drawings.

In the illustrated embodiment, the tapered edge 70 of the cathode active material layer 62 may form an acute angle 85 with the electrolyte layer 56 and an obtuse angle 87 with the cathode current collector layer 60. Additionally or alternatively, a height 88 of the cathode active material layer 62 may be between 5 and 15 micrometers in certain embodiments, and a width 90 of the tapered edge 70 may be between 5 and 20 micrometers in certain embodiments. Further, a ratio between the height 88 of the cathode active material layer and the width 90 of the tapered edge 70 may be between 1:2 and 2:1 in certain embodiments.

As shown, the cathode active material layer 62 may contact the electrolyte layer 56. However, a portion of a surface 92 of the electrolyte layer 56 may be exposed (e.g., not in contact with the cathode active material layer 62) in certain embodiments. That is, the surface 92 of the electrolyte layer 56 may include a first portion 94 in contact with the cathode active material layer 62 and a second portion 96 not in contact with (or separate from) the cathode active material layer 62. In some embodiments, the first portion 94 and the second portion 96 form a plane (e.g., the surface 92 is substantially flat across the first portion 94 and the second portion 96). A width 98 of the second portion 96 of the surface 92 may be 3.5 micrometers or less in certain embodiments (e.g., 0 to 3.5 micrometers, 0.5 to 3.25 micrometers, or 1 to 3 micrometers). A ratio between the width 98 of the second portion 96 of the surface 92 and the width 90 of the tapered edge 70 of the cathode active material layer 62 may be between 1:40 and 1:3 in certain embodiments.

As previously described, the initial charging cycle 52 described above with respect to FIG. 2 may be employed in the multi-layer battery assembly 50a of FIG. 3 to generate a lithium plating layer. For example, FIG. 4 is a schematic cross-sectional view of the multi-layer battery assembly 50b of FIG. 2 (e.g., the initial charging cycle 52 described above with respect to FIG. 2) including may of the same or similar features described above with respect to FIG. 3, but also including the lithium plating layer 54 between the electrolyte layer 56 and the anode current collector layer 58. In some embodiments, formation of the lithium plating layer 54 reduces the height 88 of the cathode active material layer 62 (e.g., the height 88 in FIG. 3 may be greater than the height 88 in FIG. 4). In other embodiments, the height 88 of the cathode active material layer 62 remains substantially the same between the multi-layer battery assembly 50a of FIG. 3 and the multi-layer battery assembly 50b of FIG. 4.

As previously described, the cathode active material layer 62 includes the tapered edge 70 extending between the cathode current collector layer 60 and the electrolyte layer 56. The tapered edge 70 of the cathode active material layer 62 is configured to promote an additional tapered edge 100 of the lithium plating layer 54 formed by way of the initial charging cycle 52 illustrated in, and described with respect to, FIG. 2. Indeed, the lithium from the cathode active material layer 62 may tend to migrate (e.g., during the initial charging cycle 52 illustrated in FIG. 2) toward the anode current collector layer 58 (e.g., through the electrolyte layer 56) in a direction generally parallel to the height 80. Accordingly, the tapered edge 70 of the cathode active material layer 62 tends to promote formation of the additional tapered edge 100 of the lithium plating layer 54. In this way, a cross-sectional width of the lithium plating layer 54 may be smaller at a position adjacent to the anode current collector layer 58 than at an additional position adjacent to the electrolyte layer 56.

As shown, the anode current collector layer 58 may move, bend, or otherwise accommodate the lithium plating layer 54 without breaking complete contact between the anode current collector layer 58 and the electrolyte layer 56 in certain embodiments. For example, the anode current collector layer 58 in the multi-layer battery assembly 50b of FIG. 4 may include a first portion 102 (e.g., flat portion) extending substantially perpendicular to the height 80 of the multi-layer battery assembly 50b and a second portion 104 (e.g., bent portion) extending from the first portion 102 and substantially following the additional tapered edge 100 of the lithium plating layer 54. In this way, as shown, the electrolyte layer 56 and the anode current collector layer 58 may maintain at least some contact adjacent to edges 106, 108 of the electrolyte layer 56 and the anode current collector layer 58, respectively.

The tapered edge 70 of the cathode active material layer 62, the additional tapered edge 100 of the lithium plating layer 54, or both negate or reduce an amount of plating activity around other edges of the multi-layer battery assembly 50b illustrated in FIG. 4, such as the edge 106 of the electrolyte layer 56 and the edge 108 of the anode current collector layer 58. Additionally or alternatively, the second portion 96 (e.g., exposed portion) of the surface 92 of the electrolyte layer 56 may contribute to the negated or reduced plating activity near the edges 106, 108 of the electrolyte layer 56 and the anode current collector layer 58, respectively. In general, such negated or reduced plating activity reduces a shorting risk of the multi-layer battery assembly 50b. In some embodiments, the contact maintained between the electrolyte layer 56 and the anode current collector layer 58 also reduces a shorting risk of the multi-layer battery assembly 50b.

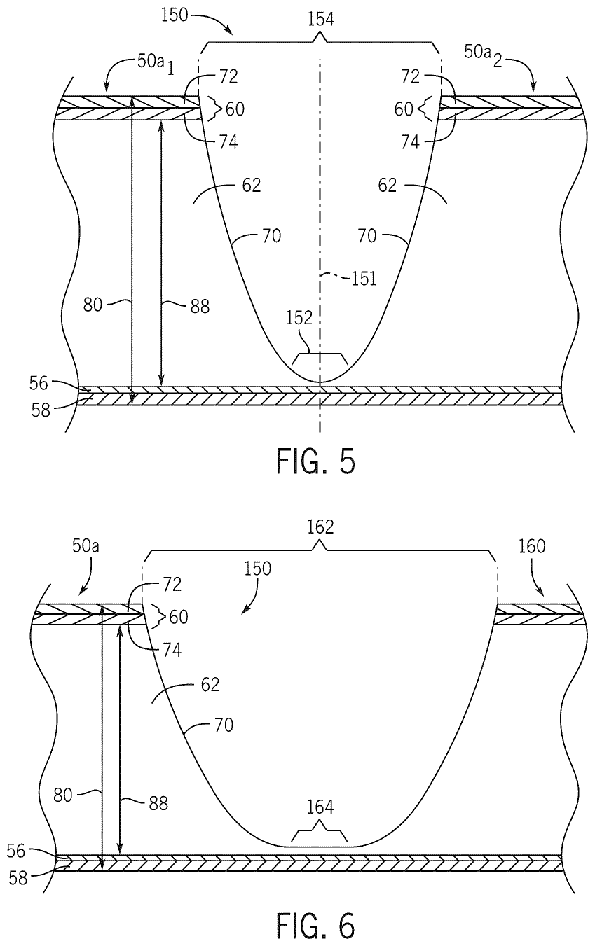

As previously described, in some embodiments, multiple instances of the multi-layer battery assembly 50a of FIG. 3 (e.g., before the initial charging cycle 52 described with respect to FIG. 2) may be interconnected in a wafer prior to being cut into individual (e.g., separate) instances of the multi-layer battery assembly 50a. For example, FIG. 5 is a schematic cross-sectional view of a portion of an embodiment of a wafer 150 including a first instance of the multi-layer battery assembly 50a₁ of FIG. 2 (e.g., before the initial charging cycle 52 described with respect to FIG. 2) and a second instance of the multi-layer battery assembly 50a₂ of FIG. 2 (e.g., before the initial charging cycle 52 described with respect to FIG. 2), where the second instance of the multi-layer battery assembly 50a₂ is connected with (and configured to be cut from) the first instance of the multi-layer battery assembly 50a₁.

The first instance of the multi-layer battery assembly 50a₁ and the second instance of the multi-layer battery assembly 50a₂ may each include the cathode current collector layer 60 (e.g., including the aluminum sub-layer 72 and the at least one additional sub-layer 74), the cathode active material layer 62, the electrolyte layer 56, and the anode current collector layer 58. As shown, the tapered edges 70 of the first instance of the multi-layer battery assembly 50a₁ and the second instance of the multi-layer battery assembly 50a₂ may by symmetrical (e.g., about a line of symmetry 151). Further, the first instance of the multi-layer battery assembly 50a₁ and the second instance of the multi-layer battery assembly 50a₂ may be connected at least by a portion 152 of the cathode active material layer 62, the electrolyte layer 56, and the anode current collector layer 58.

In some embodiments, the portion 152 of the cathode active material layer 62 is extracted (e.g., scraped, etched, or otherwise removed) from the wafer 150 before or after the first instance of the multi-layer battery assembly 50a₁ and the second instance of the multi-layer battery assembly 50a₂ are decoupled via a cutting process (e.g., a laser cutting process) from the cathode side of the wafer 150 (e.g., through the electrolyte layer 56 and the anode current collector layer 58). A groove 154 between the first instance of the multi-layer battery assembly 50a₁ and the second instance of the multi-layer battery assembly 50a₂, described in greater detail with reference to later drawings, may be shaped to accommodate the cutting process (e.g., the laser cutting process). In this way, both the first instance of the multi-layer battery assembly 50a₁ and the second instance of the multi-layer battery assembly 50a₂, following the cutting process, include the second portion 96 (e.g., exposed portion) of the electrolyte layer 56 illustrated in FIGS. 3 and 4.

FIG. 6 is a schematic cross-sectional view of a portion of an embodiment of the wafer 150 including the multi-layer battery assembly 50a of FIG. 2 (e.g., before the initial charging cycle 52 described with respect to FIG. 2) and waste material 160, where the waste material 160 is connected with (and configured to be cut from) the multi-layer battery assembly 50a. As shown, a groove 162 is formed between the multi-layer battery assembly 50a and the waste material 160. The groove 162 may be shaped to accommodate a cutting process (e.g., a laser cutting process) in which the waste material 160 is removed from the multi-layer battery assembly 50a. Further, as similarly described above with respect to FIG. 5, a portion 164 of the cathode active material layer 62 may be extracted (e.g., scraped, etched, or otherwise removed) from the wafer 150 before or after cutting (e.g., laser cutting) between the multi-layer battery assembly 50a and the waste material 160 from the cathode side of the wafer 150 and through the electrolyte layer 56 and the anode current collector layer 58.

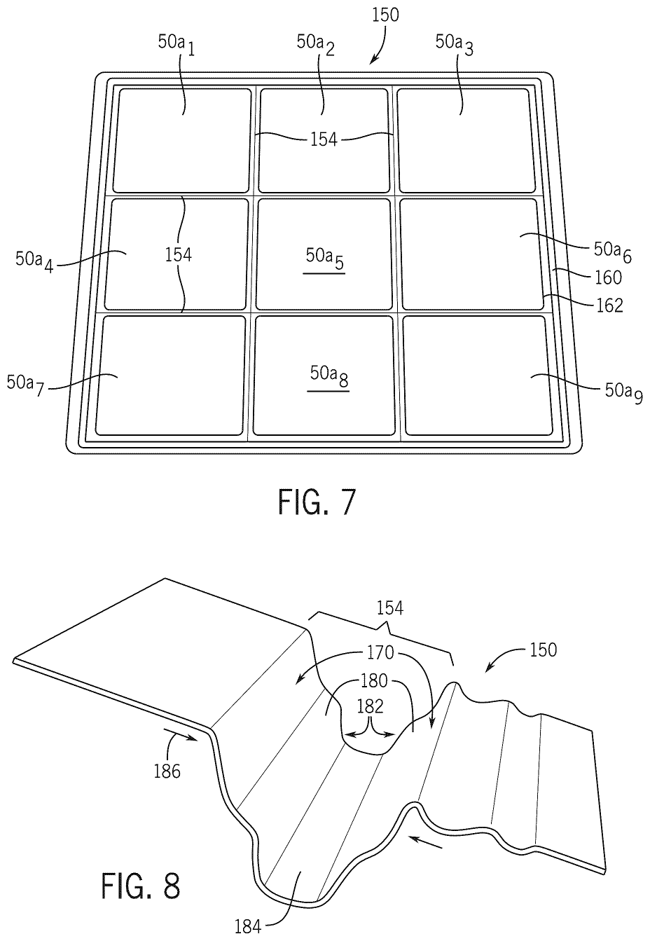

FIG. 7 is a perspective view of an embodiment of the wafer 150 including a plurality of instances of the multi-layer battery assembly 50a₁₋₉ (e.g., prior to the cutting process and/or initial charging cycle), the waste material 160 (e.g., a skeleton), and other features (e.g., the grooves 154, 162) illustrated in FIGS. 5 and/or 6. In certain embodiments, the waste material 160 (e.g., the skeleton) may extend not only along a periphery of the wafer 150, but also between adjacent instances of the multi-layer battery assembly, while in other embodiments, the wafer 150 may not include the waste material 160 (e.g., the skeleton) between the adjacent instances of the multi-layer battery assembly and/or may not include the waste material 160 (e.g., the skeleton) along the periphery of the wafer 150. In certain embodiments, an upper layer of the wafer 150 (e.g., facing upwardly from the illustrated perspective) corresponds to the cathode current collector layer 60 describe above with respect to earlier drawings. That is, the cathode current collector layer 60 may extend across a top of the wafer 150, including within the grooves 154 and/or the grooves 162. In other embodiments, at least some of the cathode current collector layer 60 is removed from the wafer 150 (e.g., along the grooves 154 and/or the grooves 162) to expose the cathode active material layer 62 (e.g., at the tapered edges 70 thereof) described above with respect to earlier drawings.

FIG. 8 is a perspective view of one of the grooves 154 in a portion of the wafer 150 of FIG. 5 and/or FIG. 7. That is, the groove 154 in FIG. 8 may be positioned between two adjacent interconnected multi-layer battery assemblies (e.g., prior to cutting). In general, the groove 154 is sized and/or shaped to accommodate the cutting process between adjacent multi-layer battery assemblies. It should be noted that FIG. 8 is merely one embodiment of the groove 154, and that other sizes and/or shapes may also be possible.

As shown, the groove 154 includes tapered surfaces 170 (or edges). In some embodiments, the tapered surfaces 170 correspond to the cathode current collector layer 60 described above with respect to earlier drawings, while in other embodiments, the tapered surfaces 170 correspond to the same tapered edges 70 (e.g., of the cathode active material layer 62) described above with respect to earlier drawings. The tapered surfaces 170 in the illustrated embodiment each include mid-sections 180 with curved surfaces 182 thereabout. The curved surfaces 182 and/or other features of the tapered surfaces 170 may facilitate a relatively wide gully 184 of the groove 154. Additionally or alternatively, the relatively large width of the gully 184 may be enabled by a relatively steep gradient of the tapered surfaces 170 between the gully 184 and the curved surfaces 182 at the mid-sections 180 of the tapered surfaces 170. For example, the tapered surfaces 170 may be steeper in this region than between a mouth 186 of the groove 154 and the curved surfaces 182 at the mid-sections 180 in certain embodiments.

In some embodiments, the gully 184 may include or be formed by a flat surface, while in other embodiments, surface corresponding to the gully 184 is curved. In general, the relatively wide gully 184 reduces negative effects associated with laser cutting, such as plasma side wall etching, that could otherwise reduce a smoothness of the battery assembly edge(s) following the cutting process and/or prevent one or more desirable lips on the electrolyte layer and/or the anode current collector layer, which are configured to reduce plating activity in undesirable locations of the multi-layer battery assemblies. Additionally or alternatively, the mouth 186 of the groove 154 may be relatively wide to facilitate access to the gully 184 during the cutting process and/or debris remove during or following the cutting process.

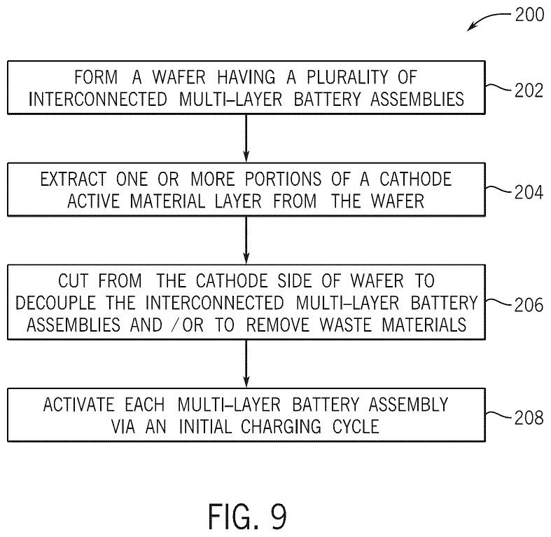

FIG. 9 is a process flow diagram illustrating an embodiment of a method 200 of manufacturing a plurality of multi-layer battery assemblies from a wafer. While certain embodiments of the method 200 may include an ordering of steps as illustrated in FIG. 9 and described in detail below, the ordering of the steps illustrated in FIG. 9 and described in detail below should not be taken as implying that all embodiments of the method 200 are performed in said order. Indeed, other orders are also possible in other embodiments of the method 200. Further, certain steps of the method 200 illustrated in FIG. 9 and described in detail below may be excluded in certain embodiments. Further still, certain steps not illustrated in FIG. 9 and/or not described in detail below may be included in certain embodiments of the method 200.

In the illustrated embodiment, the method 200 includes forming (block 202) a wafer having a plurality of interconnected multi-layer battery assemblies (e.g., multi-layer AFB assemblies). For example, the multi-layer battery assemblies may be interconnected along an anode current collector layer, an electrolyte layer (e.g., a solid-state electrolyte layer), and one or more portions of a cathode active material layer of the wafer. In some embodiments, the multi-layer battery assemblies are not interconnected along the cathode current collector layers thereof. Grooves are formed between adjacent multi-layer battery assemblies of the wafer.

The method 200 also includes extracting (block 204) one or more portions of the cathode active material layer (e.g., via scraping, etching, or otherwise removing the one or more portions) from the wafer. For example, the one or more portions of the cathode active material layer may be accessible via the grooves described above. In this way, one or more portions of the electrolyte layer are exposed along a cathode side of the wafer after extracting the one or more portions of the cathode active material layer.

The method 200 also includes cutting (block 206), such as laser cutting, from the cathode side of the wafer to decouple the interconnected multi-layer battery assemblies and/or to remove waste material therefrom. The cutting process at block 206 may be performed before or after extracting the one or more portions of the cathode active material layer described above at block 204. As previously described, the grooves between the interconnected multi-layer battery assemblies (and/or adjacent the waste material) may be shaped or otherwise configured to accommodate the cutting process through, for example, the electrolyte layer and the anode current collector layer of the wafer. By way of the cutting process, the multi-layer battery assemblies are separated from each other.

The method 200 also includes activating (block 208) each multi-layer battery assembly via an initial charging cycle. For example, as previously described, each multi-layer battery assembly may not include anode active material, but the initial charging cycle may generate a lithium plating layer between the electrolyte layer and the anode current collector layer by way of lithium in the cathode active material layer migrating toward the anode current collector layer (e.g., through the electrolyte layer). The initial charging cycles may include, for example, applying a voltage to each multi-layer battery assembly.

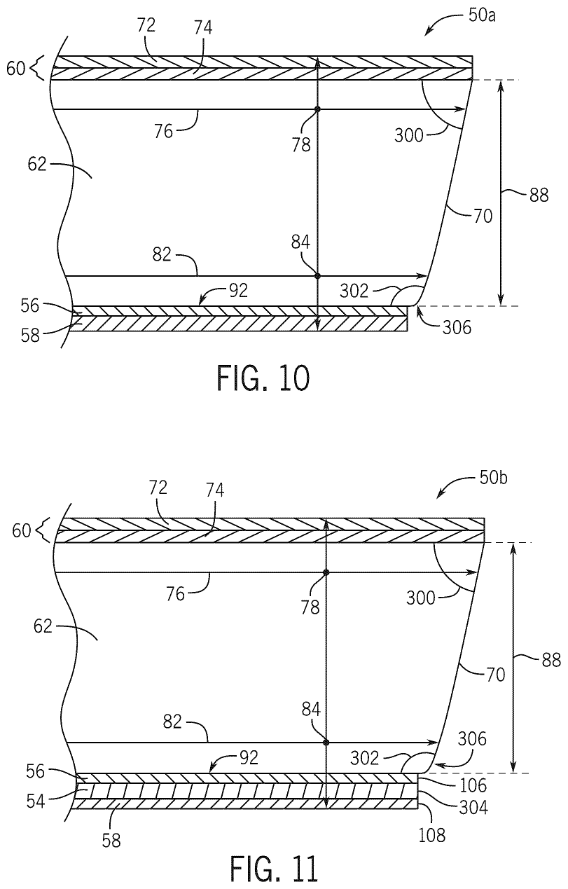

FIG. 10 is a schematic cross-sectional view of an embodiment of the multi-layer battery assembly 50a of FIG. 2 before the initial charging cycle 52. FIG. 11 is a schematic cross-sectional view of the multi-layer battery assembly 50b after the initial charging cycle 52. That is, the multi-layer battery assembly 50b of FIG. 11 may include the lithium plating layer 54 following the initial charging cycle 52 (illustrated in FIG. 2) of the multi-layer battery assembly 50a of FIG. 10.

The embodiments illustrated in FIGS. 10 and 11 include many of the same or similar features as the embodiments illustrated in FIGS. 3 and 4, respectively. However, in FIGS. 10 and 11, the tapered edge 70 of the cathode active material layer 62 is inverted relative to the embodiments illustrated in FIGS. 3 and 4, respectively. For example, in FIGS. 10 and 11, the tapered edge 70 of the cathode active material layer 62 forms an acute angle 300 (as opposed to an obtuse angle) with the cathode current collector layer 60 and an obtuse angle 302 (as opposed to an acute angle) with the electrolyte layer 56. Additionally or alternatively, in FIGS. 10 and 11, the first cross-sectional width 76 at the first location 78 along the height 80 of the multi-layer battery assembly 50a, 50b (e.g., where the first location 78 is proximate to the cathode current collector layer 60) is greater than (as opposed to less than) the second cross-sectional width 82 at the second location 84 along the height 80 (e.g., where the second location 84 is proximate to the electrolyte layer 56). Further, the lithium plating layer 54 in the multi-layer battery assembly 50b illustrated in FIG. 11 may not include a corresponding tapered edge, but instead may include a substantially vertical edge 304 substantially aligned with the edge 106 of the electrolyte layer 56 and the edge 108 of the anode current collector layer 58. Further still, the electrolyte layer 56 in FIGS. 10 and 11 may not include an exposed portion as previously illustrated and described with respect to certain earlier embodiments. That is, the surface 92 of the electrolyte layer 56 may be substantially covered by (e.g., in contact with) the cathode active material layer 62 and/or may not include an exposed portion.

In some embodiments, the tapered edge 70 is a flat slope from the cathode current collector layer 60 to the electrolyte layer 56, while in other embodiments, the tapered edge 70 may include some curvature therein (e.g., one or more curves or rounded portions therein). For example, in the embodiments illustrated in FIGS. 10 and 11, the tapered edge 70 includes a curved portion 306 (e.g., rounded portion) adjacent to the electrolyte layer 56. In some embodiments, a shape of the tapered edge 70, such as a steepness, the curved portion 306, additional curved portions, etc., may be configured to reduce manufacturing complexities associated with extracting (e.g., via laser cutting from the anode side) the multi-layer battery assembly 50a (e.g., of FIG. 11) from a wafer of multiple interconnected instances of the multi-layer battery assembly 50a.

For example, an embodiment of the present disclosure may include a wafer having multiple interconnected instances of the multi-layer battery assembly 50a in FIG. 11. Another embodiment of the present disclosure may include a method of manufacturing individual instances of the multi-layer battery assembly 50a in FIG. 11 from the above-described wafer. The wafer employing the interconnected instances of the multi-layer battery assembly 50a in FIG. 11 may share certain features of earlier described wafer embodiments and/or differ from earlier described wafer embodiments. For example, the wafer employing the interconnected instances of the multi-layer battery assembly 50a in FIG. 11 may include at least the cathode current collector layer connecting the various instances of the multi-layer battery assembly 50a in FIG. 11, where the wafer is configured to be cut (e.g., through at least the cathode current collector layer) from the anode side and into individual (e.g., discrete, separated) instances of the multi-layer battery assembly 50a in FIG. 11.

Technical benefits of presently disclosed embodiments include reduced plating activity at undesirable locations of a solid-state anode-free battery (AFB) following an initial charging cycle that generates a lithium plating layer between an electrolyte layer and an anode current collector. Other technical benefits include improved battery wafer cutting techniques and/or reduced manufacturing complexities associated therewith.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A multi-layer battery assembly comprising a cathode current collector layer, a cathode active material layer, a solid-state electrolyte layer, and an anode current collector layer, wherein:
the cathode active material layer is positioned between and in contact with the cathode current collector layer and the solid-state electrolyte layer;
the solid-state electrolyte layer is positioned between and in contact with the cathode active material layer and the anode current collector layer; and
the cathode active material layer comprises a tapered edge extending between the cathode current collector layer and the solid-state electrolyte layer.

2. The multi-layer battery assembly of claim 1, comprising:
an obtuse angle formed between the tapered edge and the cathode current collector layer; and
an acute angle formed between the tapered edge and the solid-state electrolyte layer.

3. The multi-layer battery assembly of claim 1, comprising:
an acute angle formed between the tapered edge and the cathode current collector layer; and
an obtuse angle formed between the tapered edge and the solid-state electrolyte layer.

4. The multi-layer battery assembly of claim 1, comprising a height of the cathode active material layer extending from the solid-state electrolyte layer to the cathode current collector layer, wherein the height is between 5 micrometers and 15 micrometers.

5. The multi-layer battery assembly of claim 1, wherein the solid-state electrolyte layer comprises a substantially flat surface, and wherein the substantially flat surface comprises a first portion contacting the cathode active material layer and a second portion extending beyond the cathode active material layer such that the cathode active material layer does not contact the second portion of the substantially flat surface.

6. The multi-layer battery assembly of claim 5, wherein the second portion of the substantially flat surface is between 0.5 micrometers and 3.5 micrometers.

7. The multi-layer battery assembly of claim 5, wherein the second portion of the substantially flat surface is configured to reduce or negate lithium plating at or along an edge of the solid-state electrolyte layer during or after an initial charging cycle that at least partially delithiates the cathode active material layer.

8. The multi-layer battery assembly of claim 1, wherein:
the cathode current collector layer comprises aluminum, gold, nickel, or any combination thereof;
the cathode active material layer comprises lithium cobalt oxide (LCO);
the solid-state electrolyte layer comprises glass; and
the anode current collector layer comprises copper (Cu).

9. A multi-layer battery assembly comprising a cathode current collector layer, a cathode active material layer, a solid-state electrolyte layer, a lithium plating layer, and an anode current collector layer, wherein:
the cathode active material layer is positioned between and in contact with the cathode current collector layer and the solid-state electrolyte layer;
the solid-state electrolyte layer is positioned between and in contact with the cathode active material layer and the lithium plating layer;
the lithium plating layer is positioned between and in contact with the solid-state electrolyte layer and the anode current collector layer; and
the cathode active material layer comprises a tapered edge extending between the cathode current collector layer and the solid-state electrolyte layer.

10. The multi-layer battery assembly of claim 9, wherein the lithium plating layer comprises an additional tapered edge extending between the solid-state electrolyte layer and the anode current collector layer.

11. The multi-layer battery assembly of claim 10, wherein the anode current collector layer comprises:
a portion in contact with the lithium plating layer; and
an additional portion extending from the portion, wherein the additional portion is in contact with and follows the additional tapered edge of the lithium plating layer.

12. The multi-layer battery assembly of claim 9, wherein the cathode active material layer comprises, by way of the tapered edge, a first cross-sectional width adjacent to the cathode current collector layer and a second cross-sectional width adjacent to the solid-state electrolyte layer, and wherein the second cross-sectional width is greater than the first cross-sectional width.

13. The multi-layer battery assembly of claim 12, wherein:
a height of the cathode active material layer extends from the solid-state electrolyte layer to the cathode current collector layer, the first cross-sectional width extends transverse to the height, the second cross-sectional width extends transverse to the height, and the first cross-sectional width extends parallel to the second cross-sectional width; and
the height is between 5 micrometers and 15 micrometers.

14. The multi-layer battery assembly of claim 9, wherein the solid-state electrolyte layer comprises a substantially flat surface, and wherein the substantially flat surface comprises a first portion contacting the cathode active material layer and a second portion extending beyond the cathode active material layer such that the cathode active material layer does not contact the second portion of the substantially flat surface.

15. The multi-layer battery assembly of claim 14, wherein the second portion of the substantially flat surface is between 0.5 micrometers and 3.5 micrometers.

16. The multi-layer battery assembly of claim 9, wherein:
the cathode current collector layer comprises aluminum, gold, nickel, or any combination thereof;
the cathode active material layer comprises at least partially delithiated lithium cobalt oxide (LCO);
the solid-state electrolyte layer comprises glass;
the lithium plating layer comprises lithium; and
the anode current collector layer comprises copper (Cu).

17. A wafer comprising a plurality of interconnected multi-layer battery assemblies, wherein each multi-layer battery assembly of the plurality of interconnected multi-layer battery assemblies comprises a cathode current collector layer, a cathode active material layer, a solid-state electrolyte layer, and an anode current collector layer, and wherein:
the cathode active material layer is positioned between and in contact with the cathode current collector layer and the solid-state electrolyte layer;
the solid-state electrolyte layer is positioned between and in contact with the cathode active material layer and the anode current collector layer; and
the cathode active material layer comprises a tapered edge extending between the cathode current collector layer and the solid-state electrolyte layer.

18. The wafer of claim 17, wherein the solid-state electrolyte layer comprises a substantially flat surface, and wherein the substantially flat surface comprises a first portion contacting the cathode active material layer and a second portion extending beyond the cathode active material layer such that the cathode active material layer does not contact the second portion of the substantially flat surface.

19. The wafer of claim 18, wherein the second portion of the substantially flat surface is between 0.5 micrometers and 3.5 micrometers.

20. The wafer of claim 17, wherein:
the cathode current collector layer comprises aluminum, gold, nickel, or any combination thereof;
the cathode active material layer comprises at least partially delithiated lithium cobalt oxide (LCO);
the solid-state electrolyte layer comprises glass; and
the anode current collector layer comprises copper (Cu).
